(19) United States
(12) Patent Application Publication
(10) Pub. No.: US 2013/0199500 A1
(43) Pub. Date: Aug. 8, 2013

(54) SYSTEM FOR ADAPTING AN INTERNAL COMBUSTION ENGINE SO THAT IT IS OPERATED USING COMPRESSED AIR OR GAS

(71) Applicant: Daniel Matos-Cuevas, Santo Domingo (DO)

(72) Inventor: Daniel Matos-Cuevas, Santo Domingo (DO)

(21) Appl. No.: 13/879,958

(22) PCT Filed: Oct. 5, 2011
(86) PCT No.: PCT/DO2011/000004

§ 371 Date: Apr. 17, 2013

(30) Foreign Application Priority Data
Oct. 18, 2010 (DO) P2010-0313

(51) Int. Cl. F02B 75/00

(52) U.S. Cl. CPC F02B 75/00
USPC 123/47 R

(57) ABSTRACT

The invention relates to the adaptation of an internal combustion engine so that it can be operated using compressed air instead of fuel. A system is provided for operating an internal combustion engine that has at least one cylinder and a reciprocating piston. The fuel and the spark plugs are substituted by a system that uses air or a different compressed gas as a driving force means which is supplied into the combustion chamber through the opening of the spark plug. Said system includes a differential compressor (2), a tank for storing compressed air (3), a distributing valve (4) coupled to the camshaft of the engine (1), application valves (5) connected in the openings of the spark plugs, suction (6), output (7) and drying (8 and 9) air filters, non-return valves (10), an automatic closing valve (11), a manual closing valve (12), an acceleration valve (13), a safety valve (14), an exhaust air pressure tube (15), a suction (16) and output (17) tube, suction (18) and exhaust (19) multiples, an emergency compressor (20) and atmospheric air intakes (21 and 22).

This application is the National Phase of PCT/D02011/000004 with International Publication Number WO 2012/052034, filed Oct. 5, 2011, which is based upon and claims the benefit of priority from Dominican Republic Application P2010-0313, filed on Oct. 18, 2010, the disclosure of which is incorporated herein in its entirety by reference.

### DESCRIPTION

1. Field of the Invention

The present invention is closely related to mechanical field since it involves devices that can be used to transform conventional internal combustion engines into engines capable of using energy from compressed air for functioning. This invention includes the components and parts of this conversion so the system used for obtaining this result is an engine capable of working with compressed air or gas keeping power and performance as if it were using fuel. Thus, environmental pollution is reduced one hundred percent (100%).

2. Background of the Invention

Damage caused to environment, specifically air pollution, is one of the most dramatic problems that the human race is facing today. Internal combustion engines used in vehicles are the most important contributors to deterioration of the air in our planet. So legislations contain articles devoted to this matter in order to set clear limits to pollutants internal combustion engines give off to the atmosphere. However, most of these devices have met regulations with very limited success and they are often expensive and complex.

A suitable and clean alternative is to adapt the internal combustion engine to function with compressed air or compressed gas keeping power and performance standards and reducing one hundred percent (100%) the environmental pollution.

### STATE OF THE ART

As part of the art we could include patent U.S. Pat. No. 3,885,387 entitled “AIR DRIVE ADAPTOR”, claiming priority US19730372559 19730622, and whose inventor is J. GARNET Simington, which claims a device for adapting an internal combustion engine to use compressed air. Adaptation comprehends the use of an air tank, valves for introducing the proper amount of air in the cylinder at the correct moment by means of spark plug conduct. The compressed air is fed by a compressor driven by a gasoline engine or an electric motor powered by a battery.

In the prior art is known the patent U.S. Pat. No. 4,715,181 entitled “Device to convert reciprocating piston internal-combustion engines to compressed air motors”, priority date US19860923595 19,861,027, whose inventor is Cestero LUIS G. This patent claims a device with different cameras or compressed air reservoirs, valves and pipes that deliver compressed air to the cylinders of an internal combustion engine that functions without using fossil fuels. It is also provided an adapter, which once the compressed air performs its role in the motor, takes compressed air back to the tank again by means of an electric compressor.

Prior state of art comprehends patent US2006/0191261 entitled “Gasoline engine pneumatic conversion to zero emission & fuel cost”. The inventor is Bailer, Rudolph V, SR., It was published in Aug. 31, 2006; and claims a fuel internal combustion engine that can be converted into a pneumatic motor with zero harmful emissions and zero cost of fuel. This can be accomplished by converting direct current (DC) from battery to alternating current for operating a compressed hot air device. An air supply system that can replace the hot gas and spark plug with pneumatic energy delivered to the engine through air injection caps, according to the ignition order of the engine. As the engine compresses cold air, it mixes with compressed hot air what produces a powerful reaction that causes the piston being pushed downward. When this process is repeated crankshaft (from the engine) will rotate reaching sufficient speed and torque as to cause a car moves by itself on a surface.

In the state of the art is known the patent US2008/0127932, entitled “Diesel engine conversion to pneumatic & fuel cost zero emission” whose inventor is Bailer, Rudolph V. SR., published in Jun. 5, 2008, that claims a method of converting a diesel engine into a contamination-free air engine. A conventional diesel engine could be transformed into a pneumatic engine that uses no fuel for functioning by converting direct current (DC) from battery to alternating current (AC). AC is used by the air-compressed device to deliver more than 500 PSI.

Engine compresses air at temperatures over 1000 0F. Pressure level is about 500 PSI. When cold air mixes with hot air at pressure levels above 500 PSI, a powerful reaction will occur. This reaction will push the piston downward. This movement is repeated over and over again according to the ignition order of the engine and causes the vehicle to move on a surface Patent number US06/158303 is also included in the state of the art. The title is “Method and apparatus for operating an engine on compressed gas” and, the inventor is Mr. Rogers, Leroy K. Published in Jul. 10, 1981, this patent claims a method and apparatus for operating an engine having a cylinder and a piston therein using gas. The apparatus comprises a source of compressed gas connected to a distributor which distributes the compressed gas in the cylinder. A valve is provided to selectively admit compressed gas to the cylinder when the piston is in a central position, about the upper dead point. In one embodiment of the present invention the time of opening moves the valve so that the compressed gas is admitted into the cylinder progressively before reaching the dead position of the piston, thus the engine speed increases. A further embodiment of present invention includes a valve actuator which increases the length of time the valve remains open to admit compressed gas into the cylinder as the engine speed increases.

In the prior art is known patent U.S. Pat. No. 4,715,181 whose inventor is Cesteri Luis G. It was published in Dec. 29, 1987, entitled “Device to convert reciprocating piston internal-combustion engines to compressed air motors”, and claims a conveyance device: the air compressor and reservoir is adapted to be assembled to a conventional four-stroke combustion engine in order to convert the latter into an engine functioning with compressed air. The device includes compressed air reservoirs, valves and conduits for delivering air pressure to the engine cylinders in a programmed sequence. After each movement of the air supply is exhausted to the input of a device made by the compressor delivering compressed air from the exhaust back into the tanks and in so doing, increases the air exhaust energy substantially equal to the production of useful work of the engine.

Patent U.S. Pat. No. 4,210,062 is also part of the art. It is entitled “Air conversion for internal combustion engines”, and the inventor is Plesko Edward J. It was published in Jul. 1, 1980, and, claims, conversion element having a valve for being connected to a fluid compressed air source such as air or steam, and a cylinder in an internal combustion engine. A sensor is provided which communicates with the pressure conditions in the cylinder served so that repetitive power impulses drive the piston in the cylinder as in normal operation of the internal combustion engine. The disclosure contemplates one valve element per cylinder in the engine and that the conversion is achieved by the manifolding of gas, vapor or fluid power to all cylinders through the conversion elements. Each of the conversion units is connected to the cylinders by means of the spark plugs replacing existing engines. Cyclic rate and power are adjustable.

As part of the art it is patent U.S. Pat. No. 4,102,130 entitled “Converting an internal combustion engine to a single acting engine driven by steam or compressed air”, whose inventor is Stricklin Harry Charles, publication date Jul. 25, 1978. This patent claims, the method to convert a conventional four-times cycle internal combustion engine into an engine that operates by changing the times of the valves in relation with the crankshaft and the connection of ports of the valves to a reversing valve for admitting live steam to the intake ports while connecting the exhaust ports to the atmosphere, and for reversing the connection, selectively.

Known state of art comprehends the technologies created by French Guy Negre and Cyril Negre (WO9748884, WO9937885 and WO03036088) as well as the one created by the Uruguayan inventor Armando Regusci Campomar (AU2004203395) that have been designed for application in vehicles specially designed for their engines, so they can not be adapted to a vehicle without achieving a very expensive investment and huge modifications. Then replacement of existing technologies and of the millions of vehicles coming and going all over the world is not likely to happen in the near future even when this greatly reduces pollution.

While devices mentioned in these patents allow internal combustion engines functioning with compressed air, it cannot be asserted that such performance is efficient. In addition, performance of the engine at low rpm nor has not been described or during the ignition moment. If we analyze the development of the automotive industry, especially the manufacturing of engines and fittings for reaching a greater combustion performance, we will conclude that making adaptations to the conventional internal combustion engines for functioning with compressed air without using fuel combustible (engines keeps its standards of performance) constitute an ecological, economic and technological alternative.

### DESCRIPTION OF THE INVENTION

One of the objectives of the present invention is to provide a method and apparatus for adapting an internal combustion engine to operate with compressed air or gas and be applied to every mechanism having an internal combustion engine.

Another objective is to provide an effective method and apparatus capable of keeping a constant and increasing supply of compressed gas generated as the engine speed increases, reaching speed values that are accepted for the performance of a vehicle on regular roads.

Another objective of the present invention is to provide a method and an apparatus which could be easily adapted to an internal combustion engine and transforming the conventional internal combustion engine into one that functions with compressed air or gas, and that keeps the performance standards of the former.

Another objective of the invention is to provide a method and apparatus that can reduce or eliminate environmental pollution caused by emission of waste gases from combustion, noise, and burned fossil fuels. It is possible when the engine works at low temperatures.

This invention is not a “perpetual motion”. The energy of the air depends on its enthalpy (pressure and temperature) and the volume of the container. When compressed air is heated, but containers cause thermal losses, and the compressed air is not per se a way to generate energy. It only serves to transfer it.

The following invention provides a method and apparatus for operating an internal combustion engine having at least one cylinder and a reciprocating piston. Spark plugs and fuel are replaced by a system that uses compressed air or gas as the driving force, and it is taken inside the chamber through the spark plug hole. This device includes a reservoir/container of compressed air or gas that tolerates twice the pressure that will contain; a control valve connected to the tank of compressed air or gas and the engine in order to let compressed air or gas in to the cylinder when the piston is over the top dead position inside the cylinder. An escape mechanism is placed to let the air out from the cylinder when the piston changes position from bottom dead point to top dead point.

An external power source or the internal electric compressor is needed to compress the air or gas for the first time. The latter is available for emergency. Pressure stored in the tank/container makes the system works.

Transforming a combustion engine into an air engine implies removing the following components:

1—Spark Plugs.

2—Fuel Pump.

3—Nozzles or carburetors.

4—Fuel Tank.

5—Ignition coil.

6—Spark plug wires.

7—Fuel filters.

### BRIEF DESCRIPTION OF DRAWINGS

The objectives, features and advantages of the invention will be better understood from the following description of the embodiments and alternative forms of the invention as illustrated in the enclosed drawings that have not been done to scale but making emphasis only on the illustration of the principles of the invention.

FIG. 1 is a schematic diagram of the complete system disposed in an engine;

FIG. 2 is a schematic diagram of the applicator valve.

FIG. 3 is a schematic diagram of the control valve.

FIG. 4 is a schematic diagram of differential compressor.

### DETAILED DESCRIPTION

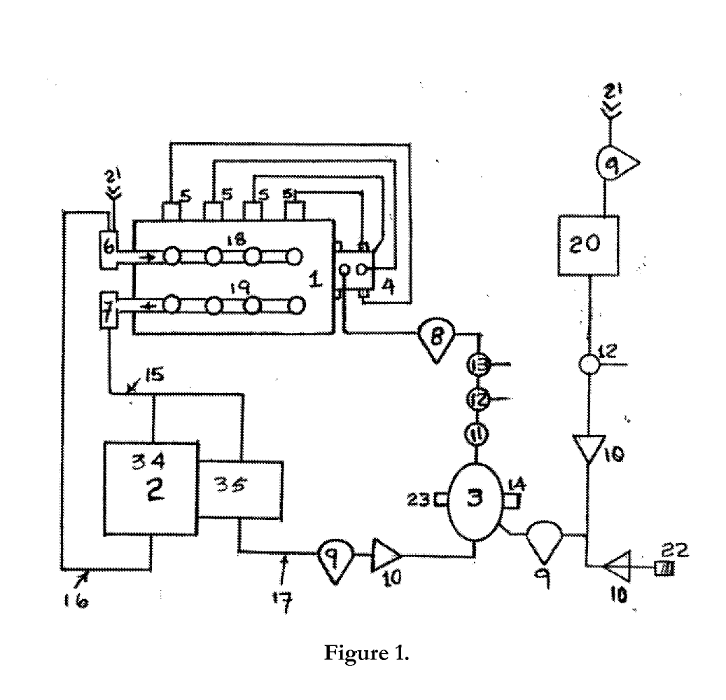

Referring to FIG. 1, a combustion engine (1) (which may be more than one cylinder), which for illustrative and not limitative purpose is explained only for engines having 4 cylinders in a row, a reservoir of compressed air or gas (3) built to tolerate twice the pressure levels that may be reached according to power required for use. It has the safety systems required by technical standards, which include calibrated safety valves for a pressure level lower than it was designed for the tank. Compressed air or gas is supplied by means of a compressor employing a differential (2) designed to work with the same pressure of the air or gas coming out of the engine through the escape mechanism (1). A distributor valve is present in the system (4) which is coupled to the engine and lets the air in the piston that is in the upper dead point of the cylinder in the previous time of explosion, through an applicator valve (6) which is responsible for letting the air in to higher pressure into the chamber through the spark plug hole. The whole system is coupled with high pressure hoses, valve and air and gas filters.

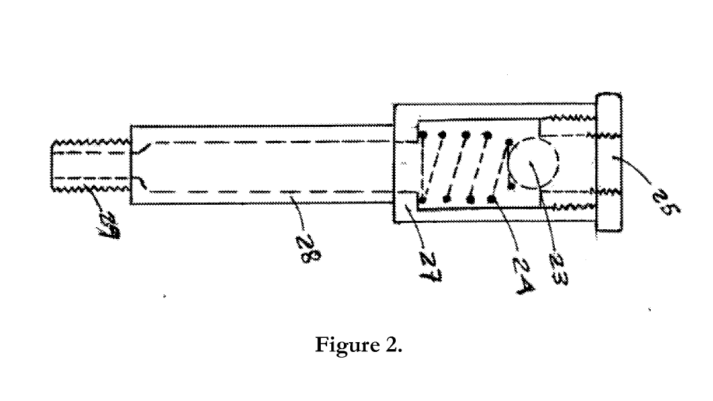

FIG. 2 is an applicator valve (5), comprising a housing split into an upper part (27), screwed to a lower part (28), which have a reduced diameter which favors the increase pressure of the fluid. A spring (24) is located in the upper part (27) as well as a sphere (23) that are compressed by the screwed lid (26) which has the hole (25) to which hoses are assembled and allow compressed air or gas. This chamber functions as a one-step valve allowing air or gas to pass in only one direction. The bottom part (28) ends in a thread that is used to screw the valve into the thread of the engine where the spark plug is installed.

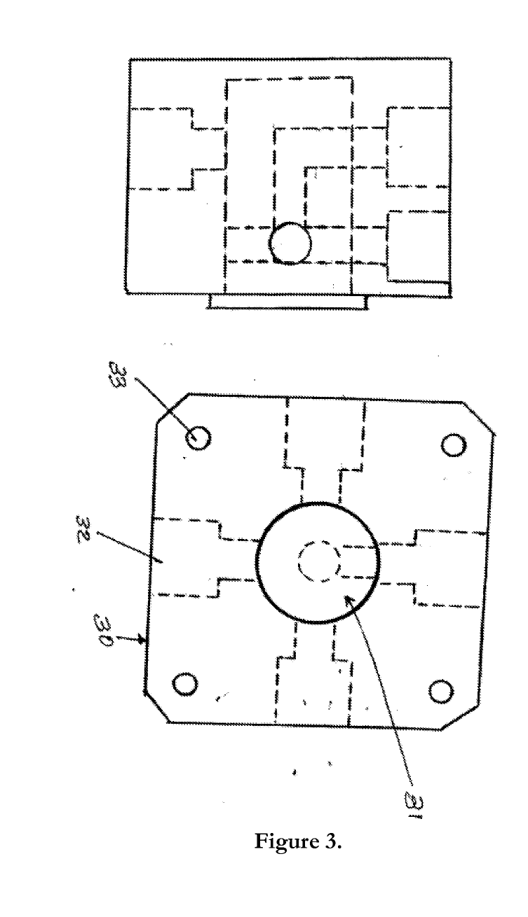

FIG. 3 corresponds to the control valve, that has the function of dosing and distributing the flow of air or gas into the cylinder placed at the explosion point, thereby air flow enters inside the cylinder or chamber and plays its role. This valve comprises an external body (30), a valve shaft (31) driven by the engine by means of the camshaft, coordinating the old ignition time of the engine in order to allow the flow of air or gas getting inside the cylinder or chamber through the holes (32) and the structure is fastened by the support holes (33).

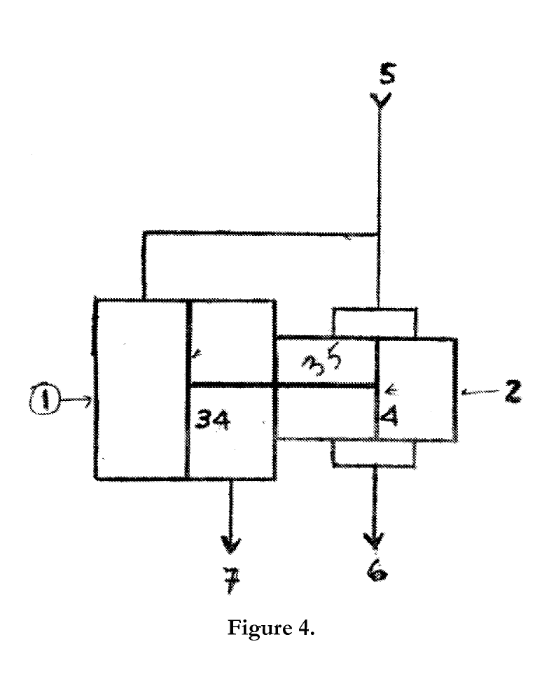

FIG. 4 is the differential compressor designed to work with the same pressure of air or gas coming out through the escape mechanism. Compressor has the function of compressing the air returning to the reservoir (3) at high pressure levels and low-pressure air is incorporated into the system through the escape mechanism (7).This compressor comprises two chambers being one of a larger diameter (34) and a other of shorter diameter (35). Already mentioned chambers house two pistons (36) and (37) connected to each other by a rod (38). Air enters through the high pressure hose (15), from the escape mechanism (7), fills chambers (34) and (35), plays its role and exits through the high pressure hose (16) to the intake manifold and high pressure hose (17) to the reservoir (3).

Descriptive Memory

Once the whole system is installed and in order to make the engine functions, it is necessary to fill the air or gas tank (3) for the first time, using an external source assembled to the inlet valve (22) or by means of the compressor (20) installed in the system which takes air from the atmosphere through the filter (9) and compresses directly in the reservoir (3) and which operates with electric power provided by the battery of the machine.

After filling the tank with air or gas observing the required pressure, the system is ready to start working. The operator proceeds opening the manual safety valve (12). Once the valve is opened, operator proceed placing the ignition key of the car or machine switch (it is not shown in the drawing) which controls the electric valve (1) and opens the flow of pressurized air or gas. Variable air flow that will cause a difference in the acceleration of the engine is obtained by pushing the accelerator pedal of the car or machine that activates the throttle valve (13) in correspondence with the needs given by motion and the decision of the operator of the system. . The pressurized air or gas coming out from the container (3) through valves (11, 12, 13) passes through the drying and particles filter (8) to be applied to the control valve (4) that distributes pressurized air or gas to the applicator valve (5) according to the corresponding order, that is to say the piston that is placed on the upper dead point, from the former explosion time of the engine.

Applicator valves (5) receive and apply this pressure to the cylinder and piston according to the ignition order of the engine (1) whatever it is. The air or gas pressure pushes the piston from upper dead point to the bottom dead point, similar to what occurs inside the cylinder or chamber. Once the air or gas performs its work bringing the piston from top dead point to bottom dead point moving the crankshaft, it takes other piston to top dead point in order to repeat the operation. Piston that performed its work is filled with air or gas. Exhaust valve is open. Piston moves from bottom dead point to upper dead point what causes the air or gas to be expelled from the cylinder or the chamber through exhaust manifold (19), entering to a particle filter (7) going through a pipe or hose (15) towards the differential compressor (2).

The differential compressor (2) has been designed especially for this application. It receives air or gas expelled through the exhaust manifold (19) at a lower pressure (pressure lower than that found inside the air or gas reservoir (3)). Differential compressor (2), given its constructive features using pressure generated at the output of the engine(1), recompressed this air or gas and drives it to the reservoir (3) along through the hoses (17) the drying and particle filter (9).

Non-return valve (10) prevents air or gas flow from returning in the reverse direction. Then air or gas directed to the reservoir (3) through the hose (17) and the particulate filter and drying (9) can not return to the differential compressor (2). The amount of air or gas coming from the low pressure section of the differential compressor (2), through the hose (6) is directed to the suction manifold of the engine (1) through the particle filter (6).

The particle filter (6) has a gas or air intake (21) that allows the engine to take some air or gas from the atmosphere in order to compensate possible loses. Suction force of the engine (1) through the hose (16) is added to the outlet pressure force coming from the lower pressure section of the differential compressor (2). This air or gas is incorporated into the cylinder or the chamber when the suction chamber is open. Suction is achieved through the intake manifold. Sucked air or gas is compressed in the cylinder or chamber during the compression cycle of the engine (1) and it is added to the air or gas coming through the applicator valve (5), then in high pressure sections of the compressor it is obtained a large compression power and high pressure of the air or gas that is being compressed again to be returned to the reservoir (3).

Safety valve (14) is placed on the reservoir (3). This valve is in charge of reducing pressure in the reservoir (3). If the pressure exceeds the maximum limits established for correct functioning, the valve opens releasing any excess pressure to the atmosphere.

There is a safety valve (23) designed to protect both the system and the people who are in the area from breakage and damage. In the presence of a car accident or collision, this valve opens and releases pressure in a very controlled manner to avoid an explosion.

The emergency system comprises an electric compressor (20) that takes air from the atmosphere through the outlet (21) and passing through the filter (3). It is delivered to the reservoir (3) through the manual valve (12). Non-return valve (10) prevents reverse return; and the filter (9) will clean up air or gas to be released in the reservoir (3).

You can also recharge the tank (3) from another external source such as a service station, an external compressor (any type or class), through the external emergency intake (22) and the non-return valve (10). These devices are only for emergency use since the system recharges by itself and just required to be charged using an external source at the first time.

The earlier embodiments of the present invention have been described in the foregoing specifications. Current invention is intended to be protected, though it is not limited to the specific uses mentioned. Instead, the information provided should be considered illustrative rather than limitative.

1. A system for adapting an internal combustion engine having at least one cylinder and a reciprocating piston to operate with compressed air or gas, having a differential compressor (2) a storage tank (3) a valve distributor (4) coupled to the engine camshaft (1) applicator valves (5) connected to the spark plug holes, the suction air filter (6), outlet (7) and drying (8) and (9), non-return valve (10) automatically closing valve (11), manual shutoff valve (12) acceleration valve (13) safety valve (14) pressure hose exhaust air (15) of suction (16) and output (17) suction manifolds (18) and exhaust (19) emergency compressor (20) and air intakes of the atmosphere (21) and (22).

2. A system for adapting an internal combustion engine having at least one cylinder and an alternative piston to work with compressed air or gas according to claim 1, by having a differential compressor designed to work with the same pressure air or gas exiting the engine exhaust manifold, consisting of two chambers of larger diameter (34) and a lower diameter (35) in said chamber there are two pistons (36) and (37) connected together by a rod (38), the air enters the low pressure hose (5) from the exhaust manifold (7) enters the chambers (34) and (35) performs its function and is expelled through the low pressure hose (16) to the intake manifold and through the high pressure hose (17) to the reservoir (3).

3. A system for adapting an internal combustion engine having at least one cylinder and a reciprocating piston functioning with compressed air or gas according to claim 1, comprising applicator valves (5) which are composed by a split case in an upper part (27) screwed to a lower part (28) that have reduced diameters that favors the increase of fluid pressure in the upper part (27) where a spring is housed (24) as well as a sphere (23) that are compressed by the lid (26) screwed into the housing having the hole (25) where hose is coupled and it lets the compressed air or gas in, this valve allows air to pass in one direction only. The bottom (28) ends in a thread used to tighten the valve in the hole where the spark plugs were installed.

4. A system for adapting an internal combustion engine having at least one cylinder and a reciprocating piston to operate with compressed air or gas according to claim 1 comprising a control valve (4) composed by an external body (30) a valve shaft (31) which is moved by the engine coupled to the camshaft to take the air or gas flow into the cylinder or chamber as required through the holes (32) and fasten the structure by means of the support holes (33).

5. A system for adapting an internal combustion engine having at least one cylinder and a reciprocating piston to operate with compressed air or gas according to claim 4 comprising the dispensing valve coupled to the engine through the camshaft what makes possible dosing and distribution of air or gas flow inside the cylinder that is in the explosion time for performing its function.

6. A system for adapting an internal combustion engine having at least one cylinder and a reciprocating piston to operate with compressed air or gas according to claim 1 comprising a modified emission manifold (6) in which the air enters through pressure hose (16), the air or gas is expelled at low pressure from the differential compressor (2) and the air intake of the atmosphere (21).

7. A system for adapting an internal combustion engine having at least one cylinder and a reciprocating piston to operate with compressed air or gas according to claim 1 comprising a manifold or exhaust pipe (7) that is substituted by hoses and differential compressor (2).

8. A system for adapting an internal combustion engine having at least one cylinder and a reciprocating piston to operate with compressed air or gas according to claim 1 comprising a tank (13) for air or compressed gas having a safety valve (14) which activates if pressure exceeds the ceilings set and releases any excess pressure to the atmosphere and a safety valve (23) which is activated by strong impacts and releases excess pressure to the atmosphere what could avoid a possible explosion.

9. A system for adapting an internal combustion engine having at least one cylinder and a reciprocating piston to operate with compressed air or gas according to claim 1 comprising an emergency system that comprehends an emergency compressor (20) electrically operated that functions taking the air from outlet (21) through air dryer filter (9) opening the manual valve (12) then passes through the non-return valve (10) and passes again through the air dryer filter (9) and is back at the reservoir (3).
